(19) United States
(12) Patent Application Publication
(10) Pub. No.: US 2005/0279205 A1
(43) Pub. Date: Dec. 22, 2005

(54) Non-lethal laser-based disorientation system

(75) Inventor: Jonathan P. Rode, Westlake Village, CA (US)

Correspondence Address: KOPPEL, JACOBS, PATRICK & HEYBL, 555 ST. CHARLES DRIVE, SUITE 107, THOUSANDS OAKS, CA, 91360, US

(73) Assignee: ROCKWELL SCIENTIFIC LICENSING, LLC

(21) Appl. No.: 10/868,485

(22) Filed: Jun. 14, 2004

(51) Int. Cl. B64D 1/04

(52) U.S. Cl. 89/1.11

(57) ABSTRACT

A non-lethal laser-based disorientation system comprises a laser light source which generates visible laser light at one or more predetermined wavelengths. When directed by an operator at an opponent whose vision is unprotected, the light disorients and/or dazzles the opponent. The system also includes an eye protection system which substantially blocks light at the predetermined wavelengths, while being substantially transparent to visible light at other wavelengths. The light source is arranged such that the fluence of the generated light does not cause permanent damage to the opponent's eyes. The generated laser light is scanned and/or diverged, to cover a large field of view, as well as to limit the light's fluence. The eye protection system preferably comprises goggles worn by an operator and associated personnel, the lenses of which have an optical coating designed to block the predetermined wavelengths while being substantially transparent to visible light at other wavelengths.

### BACKGROUND OF THE INVENTION

1. Field of the Invention

This invention relates to the field of systems for disorienting persons using light, and particularly to systems which dazzle and/or disorient using laser light while protecting those associated with the origin of the disorienting light.

2. Description of the Related Art

Many non-lethal methods of overcoming a threatening and/or dangerous opponent have been developed, and are routinely employed by law enforcement, military personnel, and others. The objective of some of these methods is to distract or temporarily disable the opponent so that they may be captured, while minimizing casualties to those employing the methods. Tear gas, pepper spray, taser guns and rubber bullets are just a few examples.

Several such methods involve the use of light to distract or disorient an opponent. For example, U.S. Pat. No. 5,837,918 to Sepp describes a rifle-like device that emits non-lethal laser light intended to “dazzle” an opponent—i.e., induce a temporary loss of vision or a temporary reduction in visual acuity. Similar light or laser-based systems are described, for example, in U.S. Pat. No. 6,367,953 to Tocci et al., U.S. Pat. No. 6,359,835 to Gayl, and U.S. Pat. No. 5,997,163 to Brown.

However, none of these light- or laser-based systems provides a means of protecting those who employ such methods from the light, while simultaneously allowing those individuals to possess the near-normal vision needed to successfully employ the system.

### SUMMARY OF THE INVENTION

A non-lethal laser-based disorientation system is provided which overcomes the drawbacks noted above. The system generates laser light sufficient to dazzle an opponent, while those associated with generating the laser light, including the operator employing the system and those personnel assigned to overcome an opponent, enjoy the near-normal vision required to use the system.

The system comprises two components. A laser light source generates visible laser light at one or more predetermined wavelengths. The light is designed such that it disorients and/or dazzles an opponent who sees the light with an unprotected eye. The system also includes an eye protection system which, when used by the operator and other associated personnel, substantially blocks light at the predetermined wavelengths, while being substantially transparent to visible light at other wavelengths—thereby allowing the operator to have the near-normal vision needed to successfully employ the system without also being disoriented by the generated light.

The laser light generated by the light source preferably has at least two predetermined wavelengths, with the eye protection system arranged to block light at each of the predetermined wavelengths while being substantially transparent to visible light at other wavelengths. The light source is arranged such that the fluence (i.e., energy/unit area) of the generated light does not cause permanent damage to the opponent's eyes. The generated laser light is scanned and/or diverged, to cover a large field of view, as well as to limit the light's fluence.

The laser light source also preferably comprises an additional low level laser light at a wavelength transparent to the eye protection system, allowing those wearing eye protection to verify the system is functional and to determine the precise area of illumination.

The eye protection system preferably comprises a visor or goggles that are worn by an operator, the lenses of which have an optical coating designed to block the predetermined wavelengths while being substantially transparent to visible light at other wavelengths.

Further features and advantages of the invention will be apparent to those skilled in the art from the following detailed description, taken together with the accompanying drawings.

### BRIEF DESCRIPTION OF THE DRAWINGS

FIG. 1a is a diagram illustrating the basic principles of the laser light generation portion of the present non-lethal laser-based disorientation system.

FIG. 1b is a graph illustrating the transmission spectrum of an eye protection system suitable for use with the laser light generation portion shown in FIG. 1a.

FIG. 2a is a diagram illustrating a preferred embodiment of the laser light generation portion of the present non-lethal laser-based disorientation system.

FIG. 2b is a graph illustrating the transmission spectrum of an eye protection system suitable for use with the laser light generation portion shown in FIG. 2a.

### DETAILED DESCRIPTION OF THE INVENTION

The present non-lethal laser-based disorientation system comprises two portions: a laser light generation portion, and an eye protection portion. The laser light generation portion is intended to provide visible laser light having at least one predetermined wavelength. The laser light is directed to illuminate a target area, with the light having a fluence sufficient to disorient or dazzle a person within the target area whose vision is unprotected—but low enough to avoid causing permanent eye damage. The eye protection portion is matched to the laser light generation portion, such that the protection system substantially blocks light at the predetermined narrow wavelength, while being substantially transparent to visible light at other wavelengths. This enables the operators of the system to direct the laser light as needed, without them or their colleagues being dazzled or disoriented themselves. The laser light must be centered about wavelengths in the visible spectrum, so that it has the desired dazzling effect on an unprotected eye.

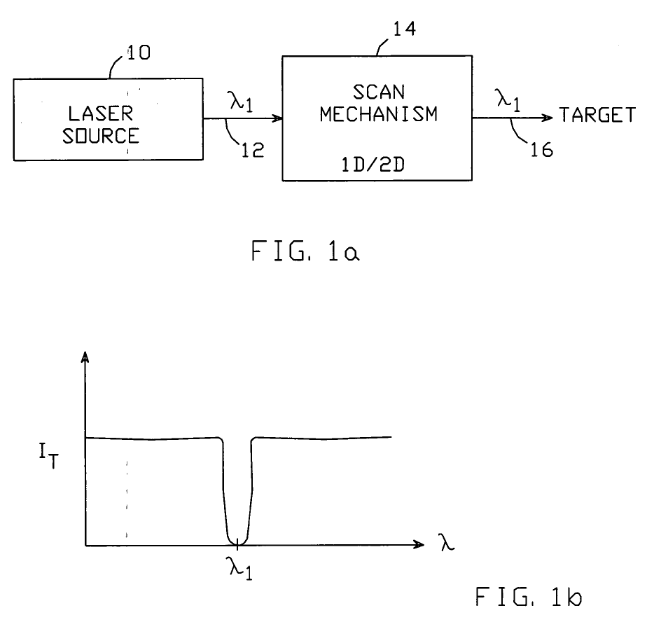

FIGS. 1a and 1b illustrate the principles of the present non-lethal laser-based disorientation system. A laser light source 10 produces laser light having at least one predetermined wavelength; in the exemplary embodiment shown in FIG. 1a, the light is centered about a wavelength λ₁. To illuminate a target area, the output 12 of laser source 10 is provided to a scanning mechanism 14—typically some combination of mirrors which rotate to scan the beam—which scans the beam in either one (1D) or two (2D) dimensions. The scanned beam 16 of visible laser light centered about wavelength λ₁ is directed at a target area. The light directed at the target area is designed to have a fluence sufficient to disorient or dazzle a person whose vision is unprotected, without causing permanent eye damage.

Sources of visible laser light and 1D and 2D scanning mechanisms are well-known to those familiar with laser technology. Equipment of this sort is described, for example, in optoelectronics industry catalogs, such as the Laser Focus Buyer's Guide, found at http://laserfocusworld.365media.com/laserfocusworld/.

The characteristics of the system's matching eye protection are shown in FIG. 1b, which plots the intensity (I_{T}) of the light transmitted through the eye protection versus wavelength (λ). In this example, the operator or operators of the laser light generation portion employ eye protection which substantially blocks light at predetermined wavelength λ₁, but which is substantially transparent to visible light at other wavelengths. The operators are thus protected from being dazzled or disoriented by the light directed at the target.

Typical applications of the present system include hostage or riot control situations, in which law enforcement personnel would—while employing eye protection as described above—operate the present system's light generation portion to dazzle or disorient persons or suspects (referred to herein as “opponents”) presumed to be dangerous to themselves or to others. By so doing, the opponents may be temporarily disoriented or distracted by the light, thereby enabling law enforcement personnel to approach and defuse the situation with little to no risk. In addition, the approach is non-lethal, with opponents suffering no lasting injury.

The present system preferably generates visible laser light having two or more distinct wavelengths, to make it more difficult for opponents to have eye protection which would defeat the system. A system generating light having two or more distinct wavelengths would include matching eye protection which substantially blocks light at each of the distinct wavelengths, while being substantially transparent to visible light at other wavelengths.

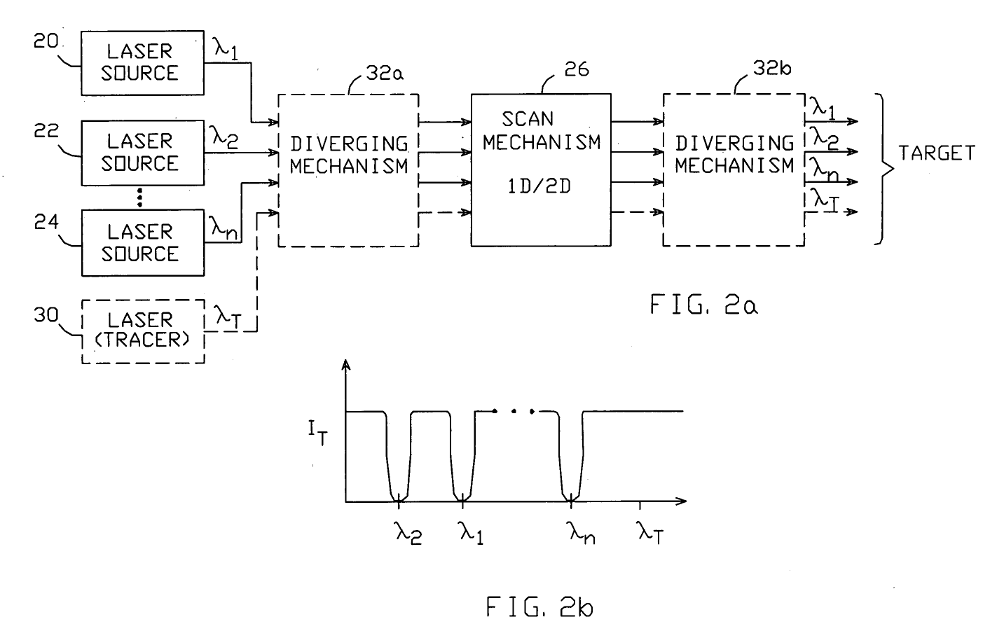

A preferred embodiment of the present system which illustrates the use of two or more distinct wavelengths is shown in FIG. 2a. Here, n laser sources 20, 22, 24 produce visible laser light at respective distinct wavelengths λ₁, λ₂, . . . , λₙ. Each of the generated beams is scanned in one or two dimensions using a scan mechanism 26, with the scanned beams at wavelengths λ₁, λ₂, . . . , λₙ directed at a target area.

The corresponding eye protection must have characteristics which match those of the generated light. This is illustrated in the graph shown in FIG. 2b. The intensity of the light (I_{T}) transmitted through the eye protection must be substantially reduced at each of wavelengths λ₁, λ₂, . . . , λₙ, while being substantially transparent to all other visible wavelengths.

The present system may optionally include a guide or tracer beam source 30, which generates visible laser light at another distinct wavelength λ_{T} which is combined with the beams at wavelengths λ₁, λ₂, . . . , λₙ. This beam is scanned via mechanism 26 in the same manner as the other beams, and directed at the target. However, as shown in FIG. 2b, the eye protection is arranged such that it does not block light at wavelength λ_{T}. In this way, an operator wearing eye protection can see verify the system is operational and determine what is being illuminated. Guide beam source 30 is arranged to produce a low intensity laser light, such that it does not dazzle, disorient, or damage even unprotected eyes.

The size of the scanned beam can be controlled in several different ways. One approach requires the use of a diverging mechanism (32a, 32b), located either before or after scan mechanism 26. A diverging mechanism receives the beams from laser sources 20, 22, 24, or the outputs of scan mechanism 26, and serves to increase the field of view covered by the generated light, as well as to reduce the fluence of the light directed at an opponent. Placing the diverging mechanism before or after scan mechanism 26 depends on several factors: for example, placing the diverging mechanism after the scanner makes scanner operation easier as there is a constant direction from which the light enters the scanner. However, now the diverging mechanism must accept light entering over a range of angles. Diverging mechanisms, such as a lens or a curved mirror, are well-known; they are described, for example, in Physical Optics, Robert W. Wood (Optical Society America, 1988).

A second approach to controlling beam size involves expanding and collimating the laser output such that all optical rays are parallel to each other. The maximum diameter of the beam is equal to the diameter of the optical aperture of the system. By using a collimated beam, the fluence of the scanned beam is almost range-independent—i.e., its fluence is nearly constant, independent of range (neglecting beam diffraction).

A diverging mechanism as described above provides a simple means by which the generated light can cover a large area. However, when a beam is diverged, its fluence decreases with increasing range. Therefore, to obtain a desired fluence at a particular distance, the output power of the laser sources must be adjusted depending on the range to the target—a longer range will require a higher output power to achieve the desired effect, while a shorter range may require a reduced output power to avoid permanent eye damage. This is not required with the range-independent characteristic of the second approach described above. However, with a parallel beam, the beam size can be very small with respect to the area to be scanned, which may place additional demands on the scan mechanism.

As noted above, the scan mechanism may scan in either one dimension—typically horizontal in this application—or two dimensions (both horizontal and vertical). Employing a 1D scan would require a beam width sufficient to provide adequate coverage in the other dimension.

The laser light generation portion of the present system might be provided by, for example, a hand-held unit, or as a vehicle-mounted unit, with the size of the unit driven by the area to be illuminated.

The eye protection portion of the present non-lethal laser-based disorientation system preferably comprises a pair of goggles or a helmet visor. To provide the eye protection required by the system, an optical filter or coating having the desired wavelength transmission and blocking characteristics would typically be applied to the visor or goggle lenses. As an alternative to goggles, such a filter or coating might be applied to a vehicle's windshield, or to a window within a protective shield held by or placed in front of the system operators, through which the operators look when directing the laser light.

Many such filters and coatings are known. Colored filters or band-stop filters, for example, can provide effective protection against laser light at a single, known wavelength. Optical interference coatings might also be employed, which can be designed to block laser light at two or more wavelengths. Such coatings are described, for example, in U.S. Pat. No. 4,756,602 to Southwell et al. and U.S. Pat. No. 4,666,250 to Southwell, as well as in co-pending patent application 10/______ to Hall and Southwell, all of which are assigned to the same assignee as the present case. Another eye protection device which might be useful, described in U.S. Pat. No. 5,828,437 to Hubert-Habart et al., blocks one or more specific wavelengths, while controlling the intensity of the light seen by a wearer.

While particular embodiments of the invention have been shown and described, numerous variations and alternate embodiments will occur to those skilled in the art. Accordingly, it is intended that the invention be limited only in terms of the appended claims.

1. A non-lethal laser-based disorientation system, comprising:
a laser light source which generates visible laser light at a predetermined wavelength, said laser light source arranged such that, when said generated light is directed by an operator at an opponent who sees said light with an unprotected eye, said light disorients and/or dazzles said opponent, said laser light source arranged such that the fluence of said light directed at said opponent does not cause permanent damage to said unprotected eye; and
an eye protection system for use by said operator and associated personnel which substantially blocks light at said predetermined wavelength while being substantially transparent to visible light at other wavelengths.

2. The system of claim 1, wherein said laser light source is arranged to generate laser light having at least two distinct predetermined wavelengths, and said eye protection system is arranged to block light at each of said predetermined wavelengths while being substantially transparent to visible light at other wavelengths.

3. The system of claim 1, wherein said laser light source comprises:
at least one laser which outputs a beam at said predetermined wavelength; and
a scanning mechanism arranged to scan said beam in at least one dimension, said scanned beam being said light directed at said opponent.

4. The system of claim 3, wherein said scanning mechanism is arranged to scan said beam so as to limit the fluence of said generated light such that said scanned beam does not cause permanent damage to said unprotected eye.

5. The system of claim 3, wherein said scanning mechanism is arranged to scan said beam such that said scanned beam covers a large field of view.

6. The system of claim 3, wherein said scanning mechanism is arranged to scan said beam in one dimension.

7. The system of claim 3, wherein said scanning mechanism is arranged to scan said beam in two dimensions.

8. The system of claim 1, wherein said laser light source comprises:
at least one laser which outputs a beam at said predetermined wavelength; and
a diverging mechanism arranged to diverge said beam to limit the fluence of said generated light such that said diverged beam does not cause permanent damage to said unprotected eye.

9. The system of claim 1, wherein said laser light source comprises:
at least one laser which outputs a beam at said predetermined wavelength; and
a diverging mechanism arranged to diverge said beam to cover a large field of view.

10. The system of claim 1, wherein said laser light source comprises:
at least one laser which outputs a beam at said predetermined wavelength;
a diverging mechanism arranged to diverge said beam; and
a scanning mechanism arranged to scan said beam in at least one dimension.

11. The system of claim 1, wherein said laser light source produces a beam which is expanded and collimated such that its optical rays are parallel to each other and which has a maximum diameter that is approximately equal to the diameter of an optical aperture through which said beam passes, such that the fluence of said beam is nearly range-independent.

12. The system of claim 1, wherein said laser light source comprises:
at least two lasers which output respective beams at respective, different visible wavelengths; and
a scanning mechanism arranged to scan said beams in at least one dimension.

13. The system of claim 1, further comprising a laser light source which generates a laser tracer beam at a wavelength different from said predetermined wavelength which is directed at said opponent with said laser light having said predetermined wavelength, said tracer beam source arranged such said tracer beam has a fluence low enough to avoid dazzling, disorienting, or causing permanent damage to an unprotected eye,
said eye protection system arranged to be substantially transparent to light at said tracer beam's wavelength.

14. The system of claim 1, wherein said laser light source comprises:
at least one laser which outputs a beam at said predetermined wavelength; and
a scanning mechanism arranged to scan said beam in at least one dimension;
said system further comprising a laser light source which generates a laser tracer beam at a wavelength different from said predetermined wavelength which is scanned with said scanning mechanism along with said laser light having said predetermined wavelength, said tracer beam source arranged such said scanned tracer beam has a fluence low enough to avoid dazzling, disorienting, or causing permanent damage to an unprotected eye,
said eye protection system arranged to be substantially transparent to light at said tracer beam wavelength.

15. The system of claim 1, wherein said eye protection system comprises goggles or visors to be worn by said operator and forces associated personnel.

16. The system of claim 1, wherein said eye protection system comprises a shield positioned between said operator and associated personnel and said laser light source, at least a portion of said shield arranged to substantially block light at said predetermined wavelength while being substantially transparent to visible light at other wavelengths.

17. The system of claim 1, wherein said eye protection system comprises an optical interference coating on an optical medium through which said operator sees, said coating arranged to substantially block light at said predetermined wavelength while being substantially transparent to visible light at other wavelengths.

18. A non-lethal laser-based system for disorienting and/or dazzling an opponent, comprising:
a laser light source, comprising:
at least two lasers which output respective beams at respective, different predetermined visible wavelengths, and
a scanning mechanism arranged to scan said beams in at least one dimension,
said laser light source arranged such that, when said scanned beams are directed by an operator at an opponent who sees said scanned beams with an unprotected eye, said scanned beams disorient and/or dazzle said opponent, said laser light source arranged such that the fluence of said scanned beams does not cause permanent damage to said unprotected eye; and
an eye protection system for use by said operator and forces associated personnel which substantially blocks light at each of said predetermined wavelengths while being substantially transparent to visible light at other wavelengths.

19. The system of claim 18, further comprising a diverging mechanism arranged to diverge said beams.

20. The system of claim 18, wherein each of said beams is expanded and collimated such that its optical rays are parallel to each other and such that said beam has a maximum diameter that is approximately equal to the diameter of an optical aperture through which said beam passes, such that the fluence of each beam is nearly range-independent.

21. The system of claim 18, further comprising a laser light source which generates a laser tracer beam at a wavelength different from said predetermined wavelengths which is scanned with said scanning mechanism along with said beams having said predetermined wavelengths, said tracer beam source arranged such said scanned tracer beam has a fluence low enough to avoid dazzling, disorienting, or causing permanent damage to an unprotected eye,
said eye protection system arranged to be substantially transparent to light at said tracer beam's wavelength.

22. The system of claim 18, wherein said eye protection system comprises goggles or visors worn by said operator and forces associated personnel.

23. The system of claim 18, wherein said eye protection system comprises a shield positioned between said operator and associated personnel and said laser light source, at least a portion of said shield arranged to substantially block light at said predetermined wavelengths while being substantially transparent to visible light at other wavelengths.

24. The system of claim 18, wherein said eye protection system comprises an optical interference coating on an optical medium through which said operator and associated personnel see, said coating arranged to substantially block light at said predetermined wavelengths while being substantially transparent to visible light at other wavelengths.
